(19) United States
(12) Patent Application Publication
(10) Pub. No.: US 2021/0319591 A1
(43) Pub. Date: Oct. 14, 2021

(54) INFORMATION PROCESSING DEVICE, TERMINAL DEVICE, INFORMATION PROCESSING SYSTEM, INFORMATION PROCESSING METHOD, AND PROGRAM

(71) Applicant: SONY CORPORATION, TOKYO (JP)

(72) Inventor: KENICHIRO OI, TOKYO (JP)

(21) Appl. No.: 17/250,787

(22) PCT Filed: Sep. 3, 2019
(86) PCT No.: PCT/JP2019/034529

§ 371 Date: Mar. 3, 2021

(30) Foreign Application Priority Data
Sep. 13, 2018 (JP) 2018-171963

(51) Int. Cl. G06T 7/00; G06T 7/30; G06T 7/70

(52) U.S. Cl. CPC G06T 7/97; G06T 7/30; G06T 2207/20228; G06T 2207/30181; G06T 7/70

(57) ABSTRACT

An information processing device (10) includes an acquisition unit (40) that acquires, from a first terminal device, first image data and first terminal information associated with the first terminal device, and a generation unit (50) that generates, on the basis of first image data, second image data corresponding to second terminal information that is different from the first terminal information.

### FIELD

The present disclosure relates to an information processing device, a terminal device, an information processing system, an information processing method, and a program.

### BACKGROUND

In recent years, various kinds of applications for a plurality of users to share a map representing a position of a body in real space via a network have been put into practical use.

For example, Patent Literature 1 discloses an information processing device capable of quickly sharing a change in position of a body in real space among users.

### CITATION LIST

### Patent Literature

Patent Literature 1: JP 2011-186808 A

### SUMMARY

### Technical Problem

However, in the above-described conventional technology, it is assumed that specifications of terminals owned by a plurality of users are the same. Therefore, there is a demand for a technique capable of sharing a position of a body in real space among users even in a case where specifications of terminals owned by a plurality of users are different.

Therefore, the present disclosure proposes an information processing device, a terminal device, an information processing system, an information processing method, and a program capable of sharing a change in position of a body in real space between terminals having different specifications.

### Solution to Problem

To solve the problem described above, an information processing device includes: an acquisition unit that acquires, from a first terminal device, first image data and first terminal information associated with the first terminal device; and a generation unit that generates, on the basis of the first image data, second image data corresponding to second terminal information that is different from the first terminal information.

Moreover, according to the present disclosure, a terminal device is provided that includes: a terminal information transmission unit that transmits first terminal information; and an acquisition unit that transmits current position information to an information processing device and acquires, from the information processing device, first image data corresponding to the first terminal information and the position information, the first image data being generated on the basis of second terminal information that is different from the first terminal information.

### BRIEF DESCRIPTION OF DRAWINGS

FIG. 1 is a schematic diagram for describing an overview of a system according to embodiments of the present disclosure.

FIG. 2 is a schematic diagram for describing position data of a body, the position data being included in a global map and local map.

FIG. 3 is a block diagram illustrating an example of a configuration of a server according to each embodiment of the present disclosure.

FIG. 4 is a schematic diagram for describing a partial global map.

FIG. 5 is a block diagram illustrating an example of a configuration of a terminal device according to each embodiment of the present disclosure.

FIG. 6 is a block diagram illustrating an example of a detailed configuration of a local map generation unit according to each embodiment of the present disclosure.

FIG. 7 is an explanatory diagram for describing a feature point set on an object.

FIG. 8 is a schematic diagram for describing an example of a configuration of feature data held by a terminal device according to a first embodiment of the present disclosure.

FIG. 9 is a schematic diagram for describing an example of a configuration of feature data held by a server according to the first embodiment of the present disclosure.

FIG. 10 is a sequence diagram illustrating an example of a flow of map update processing according to the first embodiment of the present disclosure.

FIG. 11 is a sequence diagram illustrating an example of a flow of map update processing according to the first embodiment of the present disclosure.

FIG. 12 is a sequence diagram illustrating an example of a flow of map update processing according to the first embodiment of the present disclosure.

FIG. 13 is a sequence diagram illustrating an example of a flow of processing to register in a server a terminal device used for map update processing according to the first embodiment of the present disclosure.

FIG. 14 is a sequence diagram illustrating an example of a flow of map update processing according to a modification of the first embodiment of the present disclosure.

FIG. 15 is a schematic diagram illustrating an example of image data generated by a terminal device according to a second embodiment of the present disclosure.

FIG. 16 is a schematic diagram illustrating an example of image data generated by a terminal device according to the second embodiment of the present disclosure.

FIG. 17 is a schematic diagram for describing an example of a configuration of feature data held by a terminal device according to the second embodiment of the present disclosure.

FIG. 18 is a schematic diagram for describing an example of a configuration of feature data held by a terminal device according to the second embodiment of the present disclosure.

FIG. 19 is a schematic diagram for describing an example of a configuration of feature data held by a server according to the second embodiment of the present disclosure.

FIG. 20 is a sequence diagram illustrating an example of a flow of map update processing according to the second embodiment of the present disclosure.

FIG. 21 is a sequence diagram illustrating an example of a flow of map update processing according to a modification of the second embodiment of the present disclosure.

FIG. 22 is a schematic diagram for describing an example of a configuration of feature value data held by a server according to a modification of each embodiment of the present disclosure.

FIG. 23 is a hardware configuration diagram illustrating an example of a computer that implements a function of a server and terminal device of the present disclosure.

### DESCRIPTION OF EMBODIMENTS

Hereinafter, embodiments of the present disclosure will be described in detail on the basis of the drawings. Note that, in each of the following embodiments, the same reference signs are given to the same portions, and duplicate description will be omitted.

Furthermore, the present disclosure will be described in the following item order.

1. Overview

1-1. System configuration

1-2. Example of position data

2. Configuration of map management server according to embodiments of present disclosure

3. Configuration of terminal device according to embodiments of present disclosure

4. Map update processing

5. Map update processing between plurality of terminals having different terminal information

6. Hardware configuration

### 1. Overview

### [1-1. System Configuration]

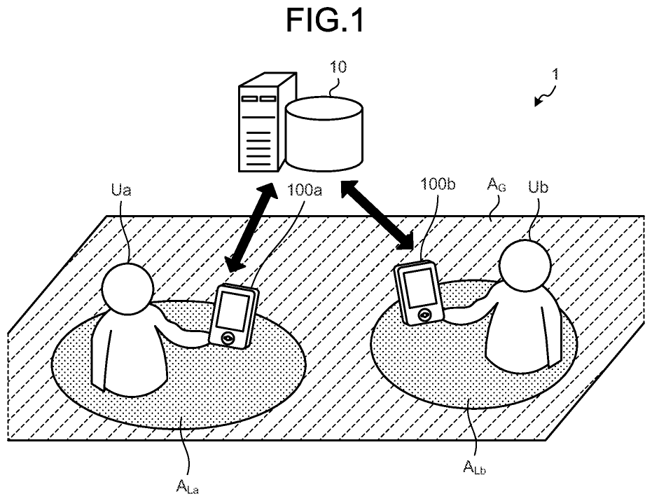

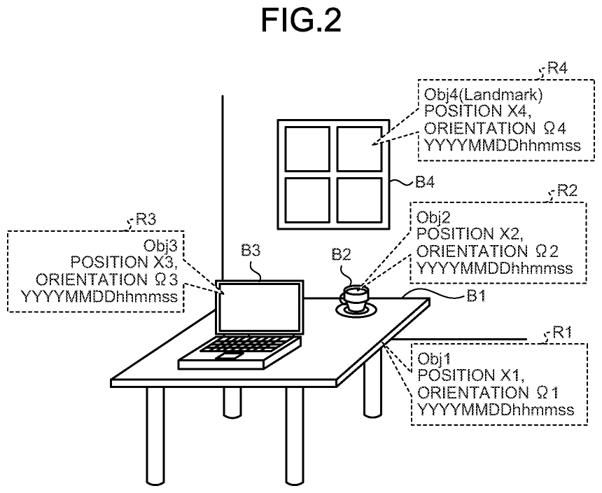

First, an overview of a system according to an embodiment of the present invention will be described by using FIGS. 1 and 2. FIG. 1 is a schematic diagram illustrating an overview of an information processing system 1 according to an embodiment of the present invention. With reference to FIG. 1, the information processing system 1 according to the present embodiment includes a map management server 10, a terminal device 100a, and a terminal device 100b.

The map management server 10 is an information processing device that provides a map sharing service for sharing a map and information associated with the map among a plurality of users. The map management server 10 has a database inside or outside a device, and stores a global map, which will be described later, in the database. The map management server 10 is typically implemented by using a general-purpose information processing device such as a personal computer (PC) or a workstation.

In the present specification, a map managed by the map management server 10 is referred to as a global map. The global map is a map that represents a position of a body in real space over an entire service target area AG of the map sharing service.

The terminal device 100a is an information processing device held by a user Ua. The terminal device 100b is an information processing device held by a user Ub. In the present specification, in a case where it is not necessary to distinguish between the terminal device 100a and the terminal device 100b, a terminal device 100 is generically referred to by omitting an alphabet at an end of a reference sign. The terminal device 100 can communicate with the map management server 10 via a wired or wireless communication connection. The terminal device 100 may typically be any type of information processing device such as a PC, a smartphone, personal digital assistants (PDA), a portable music player, or game terminal.

The terminal device 100 has a sensor function capable of detecting a position of a body around. Then, by using the sensor function, the terminal device 100 generates a local map representing a position of a body around the terminal device 100 (for example, in an area ALa or area ALb). Examples of the sensor function include simultaneous localization and mapping (SLAM) technology that can simultaneously estimate, by using a monocular camera, a position and orientation of the camera and a position of a feature point of a body shown in an input image, but the sensor function is not limited to this.

Moreover, the terminal device 100 has an update function that updates, by using a generated local map, a global map managed by the map management server 10 and has a display function that displays the latest (or any time in the past) global map. That is, for example, on a screen of the terminal device 100a, the user Ua can browse a global map updated by the terminal device 100b held by the user Ub. Furthermore, for example, on a screen of the terminal device 100b, the user Ub can browse a global map updated by the terminal device 100a held by the user Ua.

### [1-2. Example of Position Data]

FIG. 2 is a schematic diagram for describing position data of a body, the position data being included in a global map and local map.

With reference to FIG. 2, four bodies B1 to B4 existing in real space are illustrated. The body B1 is a table. The body B2 is a coffee cup. The body B3 is a notebook PC. The body B4 is a window. Of these, a position of the body B4 does not move usually. In the present specification, such a body that does not move is referred to as a non-moving body or a landmark. Furthermore, FIG. 2 also illustrates position data R1 to R4 for each of the bodies. Each of the position data R1 to R4 includes an object ID “Obj1” to “Obj4” indicating the bodies B1 to B4, position “X1” to “X4”, and orientation “Q1” to “Q4”, respectively, as well as a time stamp “YYYYMMDDhhmmss” indicating a time point when the position data is generated.

The global map is a data set including position data as exemplified in FIG. 2 of a body existing in real space over an entire service target area AG. For example, in a case where one entire building is a service target area AG, the global map may include not only position data of a body in one room as exemplified in FIG. 2 but also position data of a body in another room. A coordinate system of position data of a global map is fixedly set in advance as a global coordinate system.

Meanwhile, a local map is a data set including position data as exemplified in FIG. 2 of a body existing in real space around the terminal device 100. For example, the local map may include position data of the bodies B1 to B4 exemplified in FIG. 2. A position of an origin of the coordinate system of the local map and orientation of a coordinate axis depend on a position and orientation of a camera of the terminal device 100. Therefore, the coordinate system of the local map is usually different from the global coordinate system.

Note that a body of which position may be represented by a global map and local map is not limited to the example in FIG. 2. For example, instead of position data of a body existing indoors, position data of a body existing outdoors such as a building or car may be included in the global map and local map. In this case, the building may be a landmark.

### 2. Configuration of Map Management Server According to Embodiments of Present Disclosure

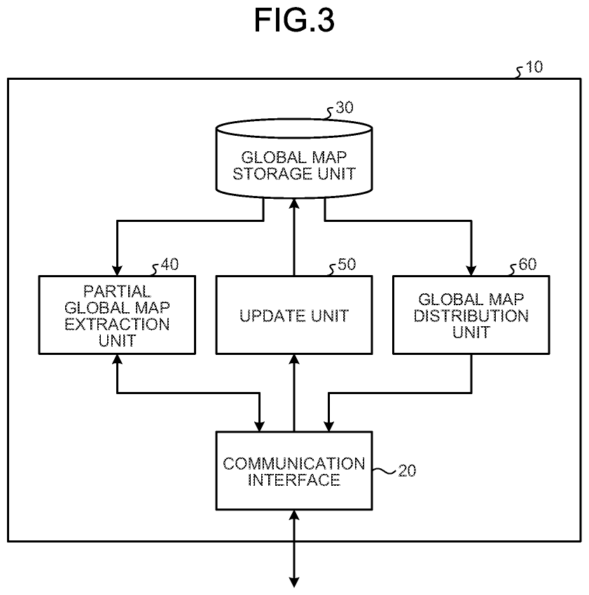

FIG. 3 is a block diagram illustrating an example of a configuration of a map management server 10 according to the present embodiment. With reference to FIG. 3, the map management server 10 includes a communication interface 20, a global map storage unit 30, a partial global map extraction unit 40, an update unit 50, and a global map distribution unit 60.

The communication interface 20 is an interface that mediates communication connection between the map management server 10 and the terminal device 100. The communication interface 20 may be a wireless communication interface or a wired communication interface.

The global map storage unit 30 corresponds to a database configured by using a storage medium such as a hard disk or a semiconductor memory, and stores the above-described global map representing a position of a body in real space in which a plurality of users are active. Then, the global map storage unit 30 outputs a partial global map that is a subset of a global map in response to a request from the partial global map extraction unit 40. Furthermore, a global map stored in the global map storage unit 30 is updated by the update unit 50. Furthermore, the global map storage unit 30 outputs an entire or requested part of the global map in response to a request from the global map distribution unit 60. Furthermore, the global map storage unit 30 stores terminal information of all terminal devices that communicate with the map management server 10. Here, the terminal information means, for example, information related to a lens, such as an angle of view of an imaging unit 110 mounted on the terminal device 100, or information related to a version of software installed in the terminal device 100. Specifically, the global map storage unit 30 stores a global map for each terminal information. In other words, a global map stored in the global map storage unit 30 is associated with terminal information. Here, in the present embodiment, a global map and a partial global map are stored as images. Therefore, in the present embodiment, a global map and a partial global map may be referred to as whole image data and partial image data, respectively.

The partial global map extraction unit 40 receives information related to a position of the terminal device 100 and terminal information related to the terminal device 100 via the communication interface 20, and extracts a partial global map according to the information. Specifically, the partial global map extraction unit 40 extracts, for example, a partial global map associated with terminal information related to the terminal device 100. Here, in a case where there exists a partial global map updated on the basis of terminal information other than the terminal device 100, the partial global map extraction unit 40 extracts the updated partial global map. Then, the partial global map extraction unit 40 transmits the extracted partial global map to the terminal device 100 via the communication interface 20. A partial global map is a subset of a global map. The partial global map represents a position of a body included in a local area around a position of the terminal device 100 in the global coordinate system.

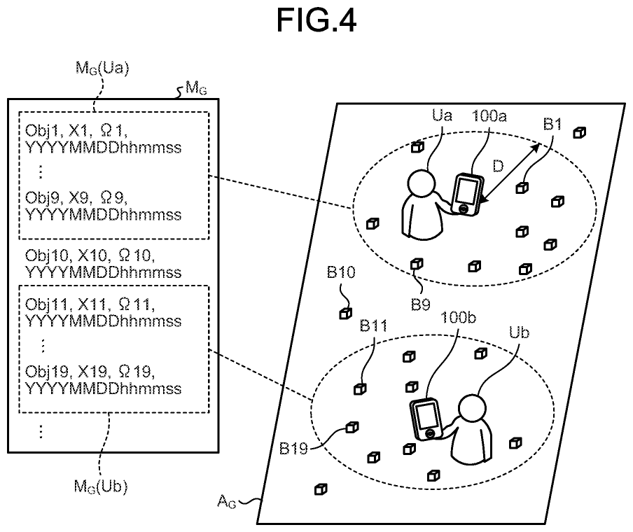

FIG. 4 is an explanatory diagram for describing a partial global map. On a left side of FIG. 4, a global map MG including position data of 19 bodies of which object IDs are “Obj1” to “Obj19” is illustrated. These 19 bodies are scattered in a service target area AG illustrated on a right side of FIG. 4. At this time, the bodies of which distance from a position of the terminal 100a held by the user Ua is equal to or less than a threshold value D are bodies B1 to B9. In this case, for example, position data of the bodies B1 to B9 are included in a partial global map MG (Ua) for the user Ua. Furthermore, the bodies of which distance from a position of the terminal 100b held by the user Ub is equal to or less than a threshold value D are bodies B11 to B19. In this case, for example, position data of the bodies B11 to B19 are included in a partial global map MG (Ub) for the user Ub. The threshold value D is set to an appropriate value in advance so that most of a range of the local map, which will be described later, is also included in the partial global map.

The update unit 50 updates a global map stored in the global map storage unit 30 on the basis of an updated partial global map received from the terminal device 100 via the communication interface 20. At this time, on the basis of information related to a position of the terminal device 100, the partial global map extraction unit 40 extracts all partial global maps associated with terminal information of each terminal device other than the terminal device 100. In this case, the update unit 50 updates the partial global maps associated with the terminal information of each terminal device other than the terminal device 100. Then, on the basis of the updated partial global maps, the update unit 50 updates a global map associated with the terminal information of each terminal device other than the terminal device 100. With this arrangement, a change in position of a body in real space is quickly reflected in the global map.

The global map distribution unit 60 distributes a global map stored in the global map storage unit 30 to the terminal device 100 in response to a request from the terminal device 100. The global map distributed from the global map distribution unit 60 is visualized on a screen of the terminal device 100 by a display function of the terminal device 100. Thus, a user is able to browse the latest (or any time in the past) global map.

### 3. Configuration of Terminal Device According to Embodiments of Present Disclosure

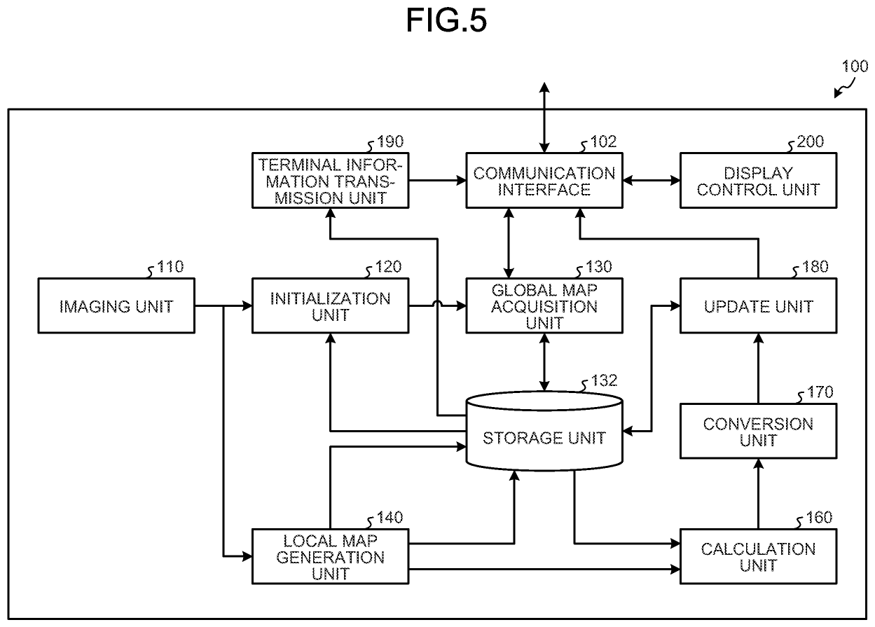

FIG. 5 is a block diagram illustrating an example of a configuration of the terminal device 100 according to the present embodiment. With reference to FIG. 5, the terminal device 100 includes a communication interface 102, the imaging unit 110, an initialization unit 120, a global map acquisition unit 130, a storage unit 132, a local map generation unit 140, a calculation unit 160, a conversion unit 170, an update unit 180, a terminal information transmission unit 190, and a display control unit 200.

The communication interface 102 is an interface that mediates communication connection between the terminal device 100 and the map management server 10. The communication interface 102 may be a wireless communication interface or a wired communication interface.

The imaging unit 110 may be implemented as, for example, a camera having an image sensor such as a charge coupled device (CCD) or a complementary metal oxide semiconductor (CMOS). The imaging unit 110 may be provided outside the terminal device 100. The imaging unit 110 outputs an image acquired by capturing an image of real space in which a body as exemplified in FIG. 2 exists as an input image to the initialization unit 120 and to the local map generation unit 140.

The initialization unit 120 identifies a rough position of the terminal device 100 in the global coordinate system by using an input image input from the imaging unit 110. Identification of a position (Localization) of the terminal device 100 based on an input image may be performed, for example, according to a method described in JP 2008-185417 A. In that case, the initialization unit 120 checks the input image against reference images stored in advance in the storage unit 132, and sets a high score for a reference image having a high degree of matching. Then, the initialization unit 120 calculates probability distribution of candidate positions of the terminal device 100 on the basis of the score, and identifies a plausible position of the terminal device 100 on the basis of the calculated probability distribution (a position having a highest probability value in a hypothetical probability distribution). Then, the initialization unit 120 outputs the identified position of the terminal device 100 to the global map acquisition unit 130.

Note that the initialization unit 120 may identify a position of the terminal device 100 by using a global positioning system (GPS) function instead of the above-described method. Furthermore, the initialization unit 120 may identify the position of the terminal device 100 by using a technology such as PlaceEngine that is capable of measuring a current position on the basis of electrometric measurement information from a wireless access point around, for example.

The global map acquisition unit 130 transmits information related to a position of the terminal device 100 to the map management server 10 via the communication interface 102, and acquires the above-described partial global map extracted by the partial global map extraction unit 40 of the map management server 10. Then, the global map acquisition unit 130 stores the acquired partial global map in the storage unit 132.

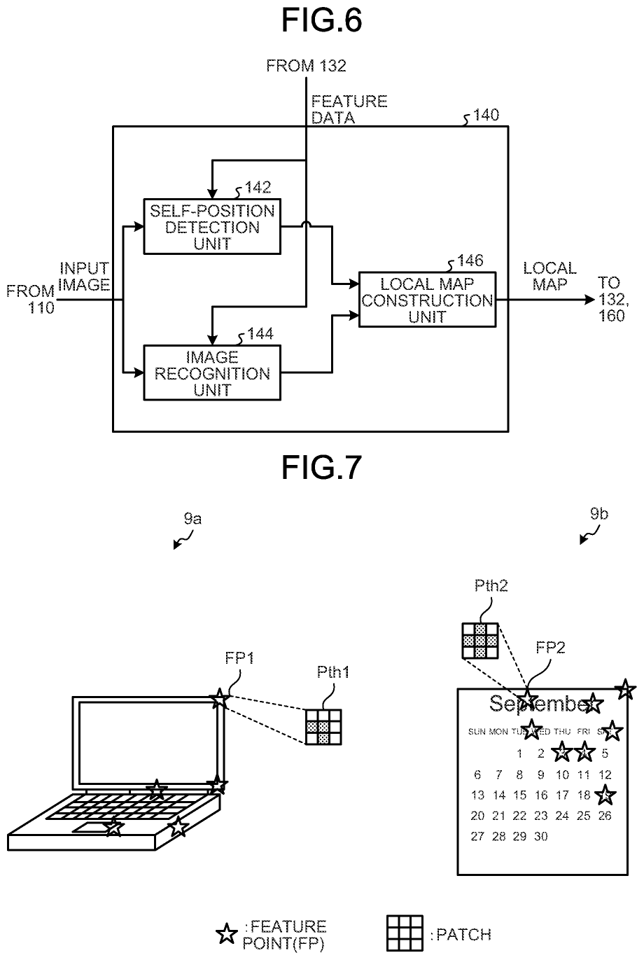

The local map generation unit 140 generates the above-described local map representing a position of a body around detectable by the terminal device 100 on the basis of input image input from the imaging unit 110 and feature data, which will be described later, stored in the storage unit 132. FIG. 6 is a block diagram illustrating an example of a detailed configuration of the local map generation unit 140 according to the present embodiment. With reference to FIG. 6, the local map generation unit 140 includes a self-position detection unit 142, an image recognition unit 144, and a local map construction unit 146.

The self-position detection unit 142 dynamically detects a position of a camera that projects the input image on the basis of an input image input from the imaging unit 110 and feature data stored in the storage unit 132. For example, the self-position detection unit 142 can dynamically determine a position and orientation of the imaging unit 110 and a position of a feature point on an imaging surface of the imaging unit 110 for each frame by using a known SLAM technology.

Here, a specific processing of the self-position detection unit 142 will be described. First, the self-position detection unit 142 initializes a state variable. The state variable is a vector including a position and orientation (rotation angle) of the imaging unit 110, a transfer rate and angular rate of the imaging unit 110, or a position of one or more feature points as a factor. The self-position detection unit 142 sequentially acquires input images from the imaging unit 110. The self-position detection unit 142 tracks a feature point shown in an input image. For example, from the input image, the self-position detection unit 142 detects a patch image for each feature point (for example, a small image of 3×3=9 pixels centered on a feature point) stored in advance in the storage unit 132. The position of the patch detected here, that is the position of the feature point, is used when a state variable is updated. The self-position detection unit 142 generates, for example, a prediction value of a state variable after one frame on the basis of a predetermined prediction model. The self-position detection unit 142 updates the state variable by using the prediction value of the generated state variable and an observation value according to the position of the detected feature point. The self-position detection unit 142 executes, for example, generation of a prediction value of a state variable and update of the state variable on the basis of a principle of the extended Kalman filter, for example. The self-position detection unit 142 outputs the updated state variable to the local map construction unit 146.

Hereinafter, content of each processing to track a feature point, predict a state variable, and update the state variable will be described more specifically.

In the present embodiment, the storage unit 132 stores in advance feature data indicating an object feature corresponding to a body that may exist in real space. The feature data includes, for example, a small image, that is a patch (Patch), of one or more feature points that indicate a feature of appearance of each object. The patch may be, for example, a small image including 3×3=9 pixels centered on a feature point.

FIG. 7 illustrates two examples of objects, as well as examples of a feature point (FP) and patch set on each object. An object on a left in FIG. 7 is an object indicating a PC (refer to 9a). A plurality of feature points including a feature point FP1 are set on the object. Moreover, a patch Pth1 is defined associated with the feature point FP1. Meanwhile, an object on a right in FIG. 7 is an object indicating a calendar (refer to 9b). A plurality of feature points including a feature point FP2 are set on the object. Moreover, a patch Pth2 is defined associated with the feature point FP2.

When acquiring an input image from the imaging unit 110, the self-position detection unit 142 checks a partial image included in the input image against the patch for each feature point, which is exemplified in FIG. 7, stored in advance in the storage unit 132. Then, the self-position detection unit 142 identifies, as a result of the checking, the position of the feature point included in the input image (for example, a position of a center pixel of the detected patch).

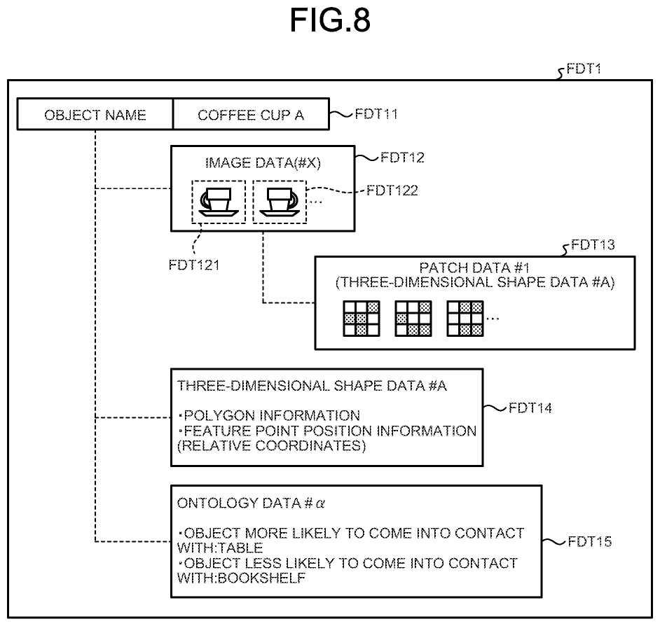

The storage unit 132 stores in advance feature data indicating an object feature corresponding to a body that may exist in real space. FIG. 8 is an explanatory diagram for describing an example of a configuration of feature data stored in the terminal device.

With reference to FIG. 8, feature data FDT1 held by a terminal device X as an example of the body B2 is illustrated. The feature data FDT1 includes an object name FDT11, image data FDT12, patch data FDT13, three-dimensional shape data FDT14, and ontology data FDT15.

The object name FDT11 is a name by which a corresponding object, such as “coffee cup A”, can be identified.

The image data FDT12 includes image data captured by the terminal device X. For example, first image data FDT121 and second image data FDT122 are included. The image data FDT12 is associated with information related to a terminal device that has imaged the image data. In the example illustrated in FIG. 8, “#X” is added to the image data that has been imaged. This means that the first image data FDT121 and the second image data FDT122 have been imaged by the terminal device X. The image data FDT12 may be used for object recognition processing by the image recognition unit 144, which will be described later.

The patch data FDT13 is a set of small images centered on each feature point for each one or more feature points set on each object. The patch data FDT13 includes, for example, one or more types of patch data numbered according to a type of patch data such as BRIEF or ORB. In the example illustrated in FIG. 8, the patch data FDT13 includes “patch data #1”. The patch data FDT13 may be used for object recognition processing by the image recognition unit 144, which will be described later. Furthermore, patch data FD13 may be used for self-position detection processing by the self-position detection unit 142 described above.

The three-dimensional shape data FDT14 includes polygon information for recognizing a shape of a corresponding object and three-dimensional position information of a feature point. The three-dimensional shape data FDT14 includes one or more types of three-dimensional shape data related to patch data included in the patch data FDT13. In the example illustrated in FIG. 8, the three-dimensional shape data FDT14 includes “three-dimensional shape data #A” related to the “patch data #1”. The three-dimensional shape data FDT14 may be used for local map construction processing by the local map construction unit 146, which will be described later.

The ontology data FDT15 is data that may be used, for example, for supporting the local map construction processing by the local map construction unit 146. The ontology data FDT15 includes one or more types of ontology data according to a terminal. In the example illustrated in FIG. 8, the ontology data FDT15 includes “ontology data #α”. Ontology data FD15 indicates that the body B2, which is a coffee cup, is more likely to come into contact with an object corresponding to a table and is less likely to come into contact with an object corresponding to a bookshelf.

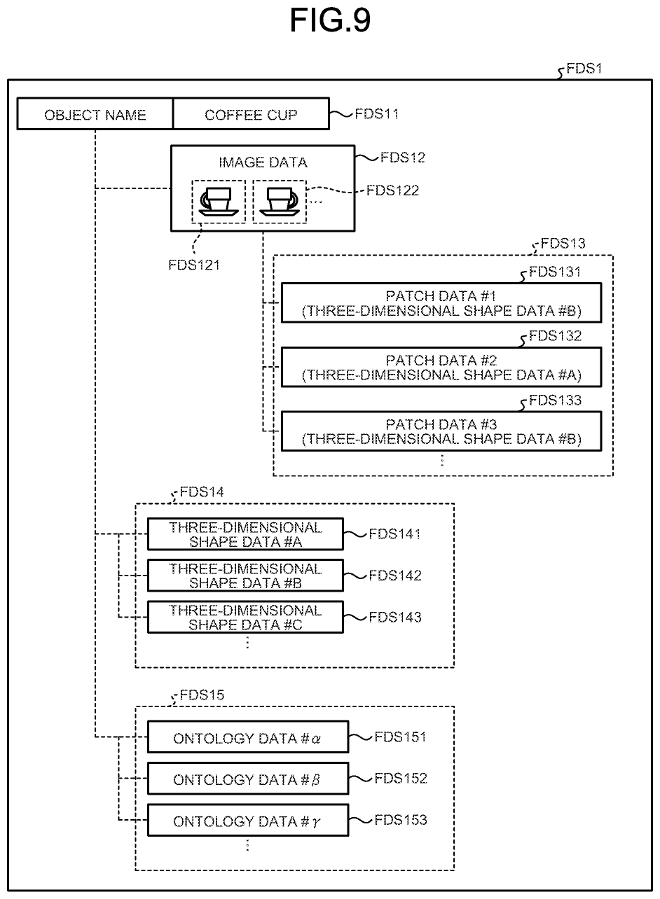

The global map storage unit 30 of the map management server 10 stores in advance feature data indicating an object feature corresponding to a body that may exist in each real space. FIG. 9 is an explanatory diagram for describing an example of a configuration of feature data stored in a map management server.

With reference to FIG. 9, feature data FDS1 held by the map management server is illustrated. The feature data FDS1 includes an object name FDS11, image data FDS12, patch data FDS13, three-dimensional shape data FDS14, and ontology data FDS15.

The object name FDS11 is a name of an object.

The image data FDS12 includes image data captured by each terminal device. The image data FDS12 includes, for example, first image data FDS121 and second image data FDS122. The first image data FDS121 and the second image data FDS122 are associated with terminal information. Specifically, for example, the first image data FDS121 is associated with terminal information of the terminal device X. For example, the second image data FDS122 is associated with terminal information of a terminal device Y. By image data included in the image data FDS12 being associated with terminal information, the map management server 10 can automatically extract image data for each terminal device. Furthermore, by image data included in the image data FDS12 being associated with terminal information, difference in image capturing condition between terminals can be absorbed. The difference in image capturing condition includes, but is not limited to, for example, an angle of view of a lens, resolution of a lens, and sensitivity of a sensor.

The patch data FDS13 includes, for example, first patch data FDS131, second patch data FDS132, and third patch data FDS133. Here, the patch data FDS13 includes all patch data handled by each terminal that communicates with the map management server 10. Furthermore, each patch data included in the patch data FDS13 is associated with three-dimensional shape data related to the patch data. In other words, information about used three-dimensional shape data is added to each patch data. Specifically, the first patch data FDS131 is patch data in which “patch data #1” is associated with “three-dimensional shape data #B”. The second patch data FDS132 is patch data in which “patch data #2” is associated with “three-dimensional shape data #A”. The third patch data FDS133 is patch data in which “patch data #3” is associated with “three-dimensional shape data #B”. Association between each patch data and each three-dimensional shape data changes according to algorithm for extracting a feature point on a terminal device side, resolution of a camera, or the like.

The three-dimensional shape data FDS14 includes, for example, first three-dimensional shape data FDS141, second three-dimensional shape data FDS142, and third three-dimensional shape data FDS143. Here, the three-dimensional shape data FDS14 includes all three-dimensional shape data handled by each terminal device that communicates with the map management server 10. Specifically, the first three-dimensional shape data FDS141 is the “three-dimensional shape data #A”. The second three-dimensional shape data FDS142 is the “three-dimensional shape data #B”. The third three-dimensional shape data FDS143 is “three-dimensional shape data #C”. The “three-dimensional shape data #A”, the “three-dimensional shape data #B”, and the “three-dimensional shape data #C” are three-dimensional shape data different from one another. The three-dimensional shape data included in the three-dimensional shape data FDS14 are associated with all types of patch data handled by each terminal that communicates with the map management server 10.

The ontology data FDS15 includes, for example, first ontology data FDS151, second ontology data FDS152, and third ontology data FDS153. Here, the ontology data FDS15 includes all ontology data handled by each terminal device that communicates with the map management server 10. Specifically, the first ontology data FDS151 is “ontology data #α”. The second ontology data FDS152 is “ontology data #β”. The third ontology data FDS153 is “ontology data #γ”. The “ontology data #α”, the “ontology data #β”, and the “ontology data #γ” are ontology data different from one another.

Refer to FIG. 6 again. The image recognition unit 144 identifies to which object each body shown in the input image corresponds by using the above-described feature data stored in the storage unit 132.

Specifically, first, the image recognition unit 144 acquires an input image from the imaging unit 110. Next, the image recognition unit 144 checks a partial image included in the input image against a patch of one or more feature points of each object included in the feature data, and extracts a feature point included in the input image. Note that a feature point used for object recognition processing by the image recognition unit 144 and a feature point used for self-position detection processing by the self-position detection unit 142 do not necessarily have to be the same. However, in a case where the object recognition processing and the self-position detection processing use a common feature point, the image recognition unit 144 may reutilize a tracking result of the feature point by the self-position detection unit 142.

Next, the image recognition unit 144 identifies an object shown in the input image on the basis of an extraction result of the feature point. For example, in a case where feature points belonging to one object in a certain area are extracted at a high density, the image recognition unit 144 may recognize that the object is shown in the area. Then, to the local map construction unit 146, the image recognition unit 144 outputs an object name (or identifier) of the identified object and a position of the feature point belonging to the object on an imaging surface.

The local map construction unit 146 constructs a local map by using a position and orientation of a camera, which are input from the self-position detection unit 142, a position of the feature point on the imaging surface, which is input from the image recognition unit 144, and feature data stored in the storage unit 132. In the present embodiment, as described above, a local map is a set of position data that represents a position and orientation of one or more bodies existing around the terminal device 100 by using a local map coordinate system. Furthermore, each position data included in a local map may be associated with, for example, an object name corresponding to a body, a three-dimensional position of a feature point belonging to the body, polygon information that configures a shape of the body, or the like. The local map may be constructed, for example from a position of a feature point on an imaging surface, which is input from the image recognition unit 144, by obtaining a three-dimensional position of each feature point according to a pinhole model.

Refer to FIG. 5 again. The calculation unit 160 checks position data of a body included in a partial global map against position data of a body included in a local map, and, on the basis of a result of the checking, calculates a relative position and orientation of the local map with respect to the global map. The relative position and orientation of a local map with respect to a partial global map correspond to displacement and inclination of a local map coordinate system based on a global coordinate system. More specifically, the calculation unit 160 may calculate a relative position and orientation of a local map on the basis of, for example, position data of a landmark commonly included in the partial global map and the local map. Instead, in a case where, for example, position data of a body included in a local map is converted into data of a global coordinate system, the calculation unit 160 may calculate a relative position and orientation of a local map so that difference between the converted data and the position data of the body included in the partial global map is small as a whole. Then, the calculation unit 160 outputs the calculated relative position and orientation of the local map and the local map to the conversion unit 170.

The conversion unit 170 performs coordinate conversion on the position data of the body included in the local map into data of a coordinate system of the global map according to the relative position and orientation of the local map input from the calculation unit 160. More specifically, for example, the conversion unit 170 rotates a three-dimensional position (local map coordinate system) of the body included in the local map by using a rotation matrix according to inclination ΔΩ of the local map input from the calculation unit 160. Then, the conversion unit 170 adds the relative position of the local map (displacement ΔX of the local map coordinate system with respect to the global coordinate system) input from the calculation unit 160 to the coordinates after rotation. Thus, the position data of the body included in the local map is converted into data of the coordinate system of the global map. The conversion unit 170 outputs position data of a body included in a local map after such coordinate conversion to the update unit 180.

Furthermore, the conversion unit 170 may perform coordinate conversion on a relative position and orientation of the camera of the local map coordinate system detected by the self-position detection unit 142 of the local map generation unit 140 into data of the coordinate system of the global map by using the relative position and orientation of the local map input from the calculation unit 160. Thus, the position of the terminal device 100 identified by the initialization unit 120 can be updated in response to movement of the terminal device 100 after the initialization. After that, the global map acquisition unit 130 may acquire a new partial global map from the map management server 10 according to the updated new position of the terminal device 100.

The update unit 180 updates the partial global map stored in the storage unit 132 by using the position data of the body included in the local map after the coordinate conversion by the conversion unit 170. Specifically, the update unit 180 generates terminal information related to the terminal device 100 in the partial global map, and associates the generated terminal information with the partial global map. For example, to image data, the update unit 180 adds information indicating that the image data has been imaged by the terminal device 100. The update unit 180 associates patch data used in the terminal device 100 with three-dimensional shape data. Furthermore, the update unit 180 updates the global map held by the map management server 10 by transmitting, to the map management server 10, the local map after the coordinate conversion by the conversion unit 170 or the updated partial global map. The update of the global map may be performed finally by the update unit 50 of the map management server 10 that has received the local map after coordinate conversion or the updated global map from the update unit 180 of the terminal device 100.

The terminal information transmission unit 190 reads terminal information related to the terminal device 100 from the storage unit 132. The terminal information transmission unit 190 transmits the read terminal information to the map management server 10 via the communication interface 102. In the present embodiment, for example, the global map acquisition unit 130 transmits information related to the position of the terminal device 100 to the map management server 10, while the terminal information transmission unit 190 transmits terminal information to the map management server 10.

The display control unit 200 downloads a global map from the map management server 10 in response to an instruction from the user, visualizes the global map at least partially, and outputs the global map to a screen of the terminal device 100. More specifically, for example, when detecting an instruction input from the user, the display control unit 200 transmits a global map transmission request to the global map distribution unit 60 of the map management server 10. Then, the global map stored in the global map storage unit 30 is distributed from the global map distribution unit 60 of the map management server 10. The display control unit 200 receives the global map, visualizes the position of the body in an area desired by the user (which may be an area other than the area where the user is currently positioned), and outputs the visualized position to the screen.

### 4. Map Update Processing

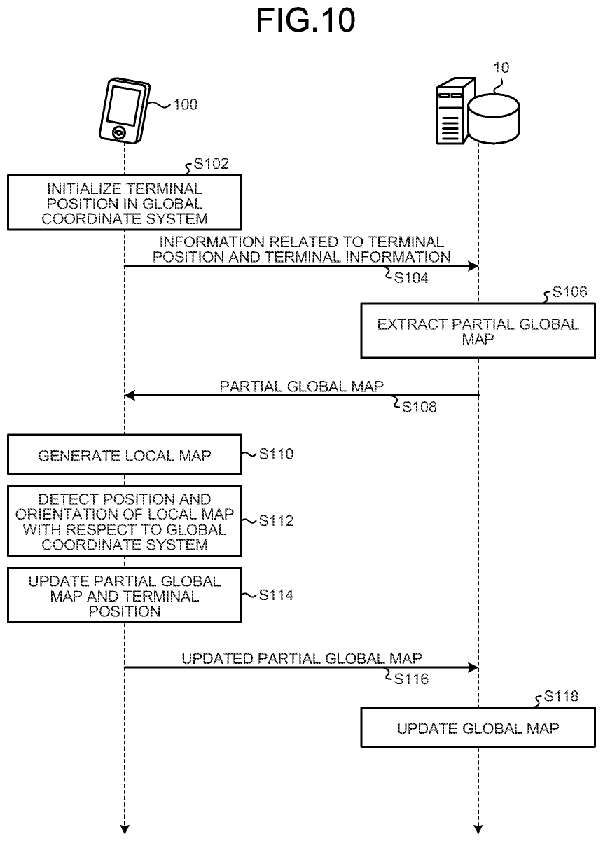

The map update processing between the map management server 10 and the terminal device 100 according to the present embodiment will be described by using FIG. 10. FIG. 10 is a sequence diagram illustrating an example of a flow of map update processing between the map management server 10 and the terminal device 100 according to the present embodiment.

With reference to FIG. 10, first, the initialization unit 120 of the terminal device 100 initializes a position of the terminal device 100 in the global coordinate system by using an input image input from the imaging unit 110 (Step S102). Initialization processing by the initialization unit 120 may be performed, for example, when the terminal device 100 starts up, when a predetermined application starts up in the terminal device 100, or the like.

Next, the information related to the position of the terminal device 100 in the global coordinate system and the terminal information of the terminal device 100 are transmitted from the global map acquisition unit 130 of the terminal device 100 to the map management server 10 (Step S104). The information related to the position of the terminal device 100 may be, for example, coordinates in the global coordinate system of the terminal device 100, or, instead, may be an area identifier for identifying the area where the terminal device 100 is positioned.

Next, the partial global map extraction unit 40 of the map management server 10 extracts a partial global map associated with terminal information of the terminal device 100 from the global map storage unit 30 on the basis of the information related to the position of the terminal device 100 and the terminal information (Step S106). Specifically, in Step S106, a partial global map is extracted by sifting through patch data, three-dimensional shape data, and ontology date according to the terminal device 100. Note that in Step S106, the partial global map may be updated by sifting through the image data as well.

Next, the partial global map associated with the terminal information of the terminal device 100 is transmitted from the partial global map extraction unit 40 of the map management server 10 to the global map acquisition unit 130 of the terminal device 100 (Step S108).

Next, the local map generation unit 140 of the terminal device 100 generates a local map representing a position of a body around on the basis of the input image and the feature data (Step S110).

Next, the calculation unit 160 of the terminal device 100 calculates a relative position and orientation of the local map based on a global coordinate system, on the basis of the position data of the body included in the partial global map and the position data of the body included in the local map (Step S112). Then, the conversion unit 170 performs coordinate conversion on the position data of the body included in the local map into data of a global coordinate system according to the relative position and orientation of the local map calculated by the calculation unit 160.

Next, the update unit 180 of the terminal device 100 updates the partial global map stored in the storage unit 132 of the terminal device 100 by using the position data of the body included in the local map after the coordinate conversion. Furthermore, the position of the terminal device 100 in the global coordinate system is updated. Furthermore, data in which the patch data and the three-dimensional shape data are associated is generated. Moreover, the input image input from the imaging unit 110 is associated with the terminal information related to the terminal device 100 (Step S114).

Next, the updated partial global map is transmitted from the update unit 180 of the terminal device 100 to the update unit 50 of the map management server 10 (Step S116).

Then, the update unit 50 of the map management server 10 updates the global map stored in the global map storage unit 30 by using the position data of the body included in the updated partial global map. Furthermore, a partial global map associated with terminal information of each terminal device other than the terminal device 100, which is not extracted in Step S106, is extracted. Specifically, patch data, or the like, that has not been extracted in Step S106 is detected. Furthermore, on the basis of the partial global map updated in Step S114, a partial global map associated with the terminal information of each terminal device other than the terminal device 100 is updated. Then, on the basis of the updated partial global map, the global map associated with the terminal information of each terminal device and stored in the global map storage unit 30 is updated (Step S118). Furthermore, in Step S118, in a case where the same body is registered in the global map more than once, the update unit 50 integrates the same bodies into one when updating the global map. Specifically, the update unit 50 integrates the body registered more than once by, for example, leaving only one of the plurality of bodies and deleting the rest.

### 5. Map Update Processing Between Plurality of Terminals Having Different Terminal Information

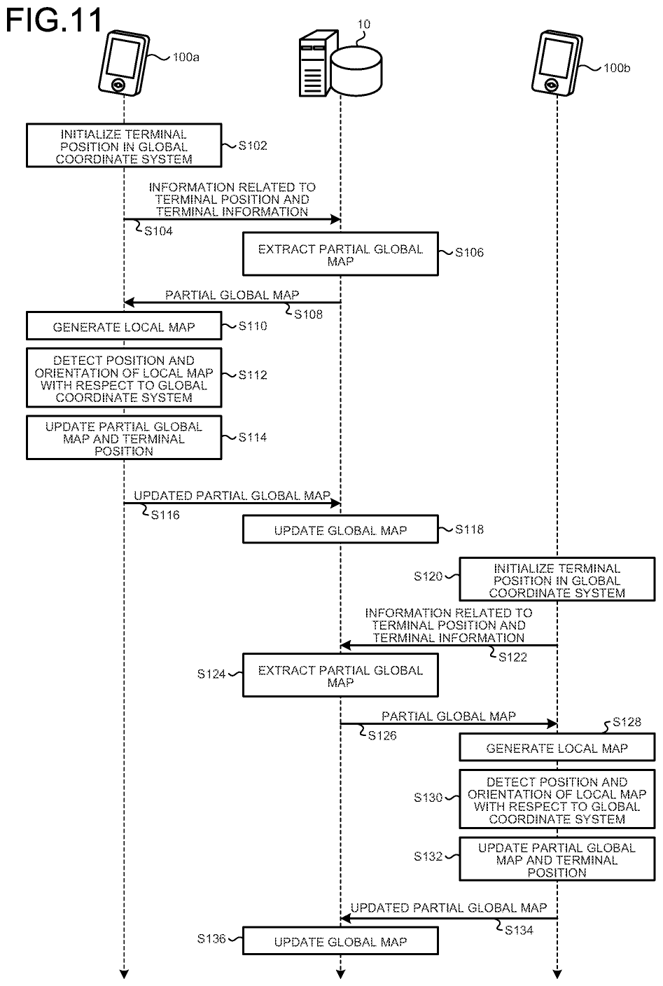

Processing to update a global map between a plurality of terminals having different terminal information will be described by using FIG. 11. FIG. 11 is a sequence diagram illustrating an example of a flow of processing to update a global map between a plurality of terminals.

FIG. 11 illustrates a flow of processing to update the global map between the map management server 10, the terminal device 100a, and the terminal device 100b.

Because the processing in Step S102 to Step S118 illustrated in FIG. 11 is similar to the processing in Step S102 to Step S118 in FIG. 10, the description thereof will be omitted.

An initial position of the terminal device 100b is initialized in a similar method to Step S102 (Step S120).

Next, information related to a position of the terminal device 100b and terminal information of the terminal device 100 are initialized in a similar method to Step S104 (Step S122).

Next, the partial global map extraction unit 40 of the map management server 10 extracts a partial global map associated with terminal information of the terminal device 100b from the global map storage unit 30 on the basis of the information related to the position of the terminal device 100b and the terminal information (Step S124). Here, the partial global map associated with the terminal information of the terminal device 100b updated by the update unit 50 in Step S118 is extracted.

Next, the partial global map associated with the terminal information of the terminal device 100b is transmitted from the partial global map extraction unit 40 of the map management server 10 to the global map acquisition unit 130 of the terminal device 100b, the terminal information of the terminal device 100b being updated by the update unit 50 in Step S118 (Step S126).

Next, the local map generation unit 140 of the terminal device 100b generates a local map representing a position of a body around on the basis of the input image and the feature data (Step S128). Here, because the terminal device 100b receives the partial global map updated in Step S118, the terminal device 100b can recognize even a body new to the terminal device 100b as a known body. With this arrangement, for example, calculation speed is improved.

Because the processing in Step S130 to Step S136 is similar to the processing in Step S112 to Step S118, the description thereof will be omitted.

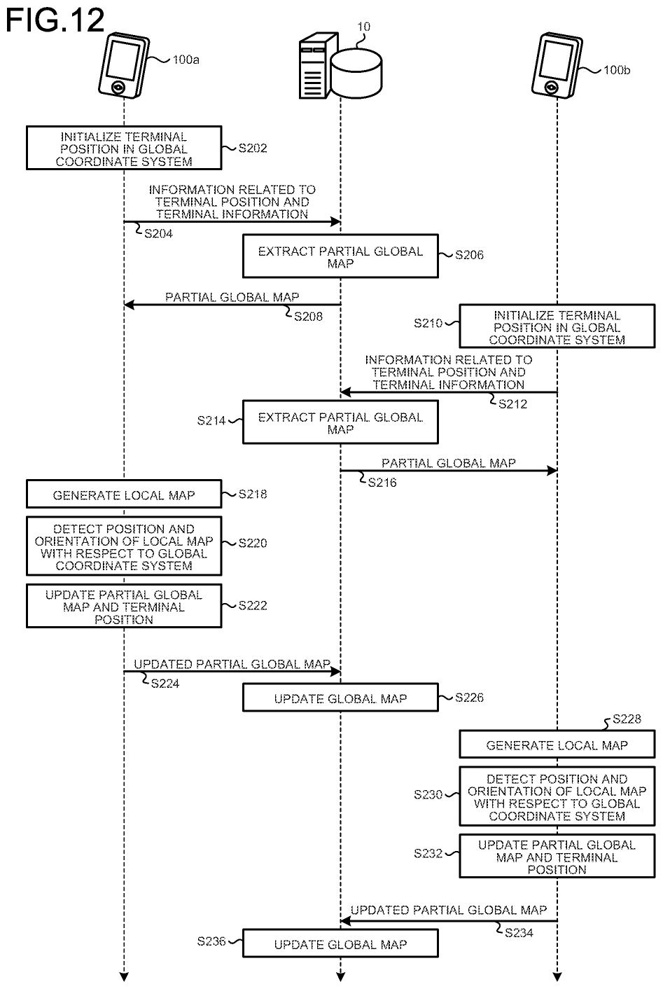

Processing to update a global map in parallel between a plurality of terminals having different terminal information will be described by using FIG. 12. FIG. 12 is a sequence diagram illustrating an example of a flow of processing to update a global map in parallel between a plurality of terminals.

FIG. 12 illustrates a flow of processing to update the global map in parallel between the map management server 10, the terminal device 100a, and the terminal device 100b.

Because Step S202 to Step S208 are similar to Step S102 to Step S108 illustrated in FIG. 10, description thereof will be omitted.

The initialization unit 120 of the terminal device 100b initializes a position of the terminal device 100b in the global coordinate system by using an input image input from the imaging unit 110 (Step S210).

Next, the information related to the position of the terminal device 100b in the global coordinate system and the terminal information of the terminal device 100b are transmitted from the global map acquisition unit 130 of the terminal device 100b to the map management server 10 (Step S212). That is, the terminal device 100b transmits information related to the position of the terminal device 100b and information related to the position of the terminal device 100b before the global map stored in the map management server 10 is updated by the terminal device 100a.

Next, the partial global map extraction unit 40 of the map management server 10 extracts the partial global map associated with terminal information of the terminal device 100b from the global map storage unit 30 on the basis of the information related to the position of the terminal device 100 and the terminal information (Step S214). Here, the partial global map before being updated is extracted on the basis of the partial global map transmitted from the terminal device 100a.

Next, the partial global map associated with the terminal information of the terminal device 100b is transmitted from the partial global map extraction unit 40 of the map management server 10 to the global map acquisition unit 130 of the terminal device 100b (Step S216).

Because Step S218 to Step S226 are similar to Step S110 to Step S118 illustrated in FIG. 10, description thereof will be omitted.

Because processing performed in Step S228 to Step S234 is similar to the processing in Step S110 to Step S116 illustrated in FIG. 10, description thereof will be omitted.

After the processing in Step S234, the update unit 50 of the map management server 10 updates the global map stored in the global map storage unit 30 by using the position data of the body included in the updated partial global map. Furthermore, a partial global map associated with terminal information of each terminal device other than the terminal device 100b, which is not extracted in Step S214, is extracted. Furthermore, on the basis of the partial global map updated in Step S232, a partial global map associated with the terminal information of each terminal device other than the terminal device 100 is updated. Then, on the basis of the updated partial global map, the global map associated with the terminal information of each terminal device and stored in the global map storage unit 30 is updated (Step S236). Here, in Step S226, the global map stored in the global map storage unit 30 is updated by the terminal device 100a. In this case, when the global map is updated in Step S236, the same body may be registered more than once. Therefore, the update unit 50 determines whether or not the body is registered more than once in the global map. In a case where a body is registered more than once, the update unit 50 integrates the body registered more than once and cancels duplicate registration. Specifically, the update unit 50 deletes a body so as to leave only one of the bodies registered more than once, for example. Note that there is no particular limitation on a method by which the update unit 50 determines whether or not the body is registered more than once in the global map. For example, in a case where there exists a plurality of bodies of which deviation amount of orientation with respect to an absolute position is equal to or less than a certain value, the update unit 50 determines that the plurality of bodies are the same bodies. For example, the update unit 50 compares image feature values of a plurality of bodies, and in a case where a matching score is equal to or higher than a certain score, determines that the plurality of bodies are the same bodies

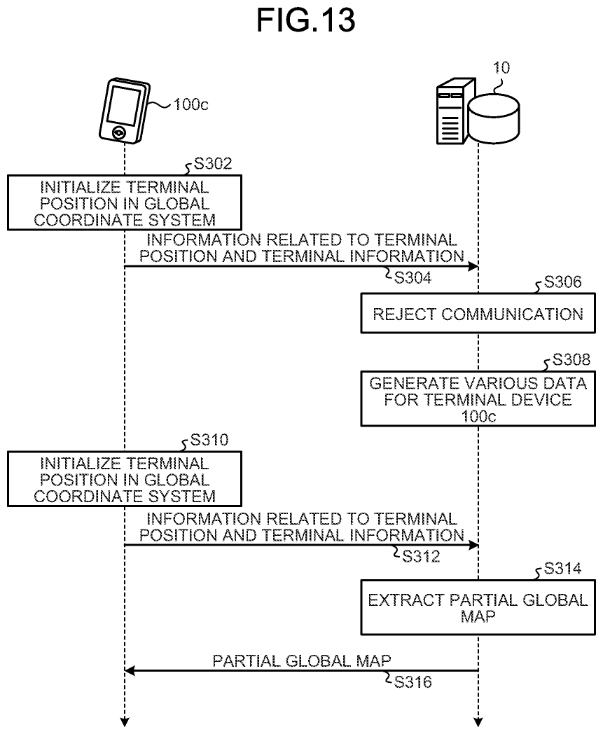

Processing to register a new terminal device in the map management server will be described by using FIG. 13. FIG. 13 is a sequence diagram illustrating an example of a flow of processing to register a terminal device in a server.

FIG. 13 illustrates a flow of processing between the map management server 10 and a terminal device 100c not registered in the map management server 10.

Because the processing in Step S302 and Step S304 is similar to the processing in Step S102 and Step S104 illustrated in FIG. 10, the description thereof will be omitted.

After the processing in Step S304, the map management server 10 rejects communication from the terminal device 100c because the map management server 10 does not store terminal information of the terminal device 100c (Step S306). In such a case, in order to cause the map management server 10 and the terminal device 100c to execute communication between each other, for example, the user registers the terminal information of the terminal device 100c in the map management server 10.

Next, the update unit 50 generates various data for the terminal device 100c, which are associated with the terminal information of the terminal device 100c (Step S308). Specifically, the update unit 50 generates patch data, three-dimensional shape data, and ontology data for the terminal device 100c. With this arrangement, communication becomes possible between the map management server 10 and the terminal device 100c.

Because Step S310 to Step S316 are similar to Step S102 to Step S108 illustrated in FIG. 10, the description thereof will be omitted. In this way, even in a case where a new terminal device appears, the map management server and the new terminal device can communicate with each other by registering terminal information in the map management server.

Note that, in FIGS. 10 to 13, processing between a plurality of terminal devices having different terminal information and a map management server will be described. More specifically, the plurality of terminal devices may have different feature values extracted from an image.

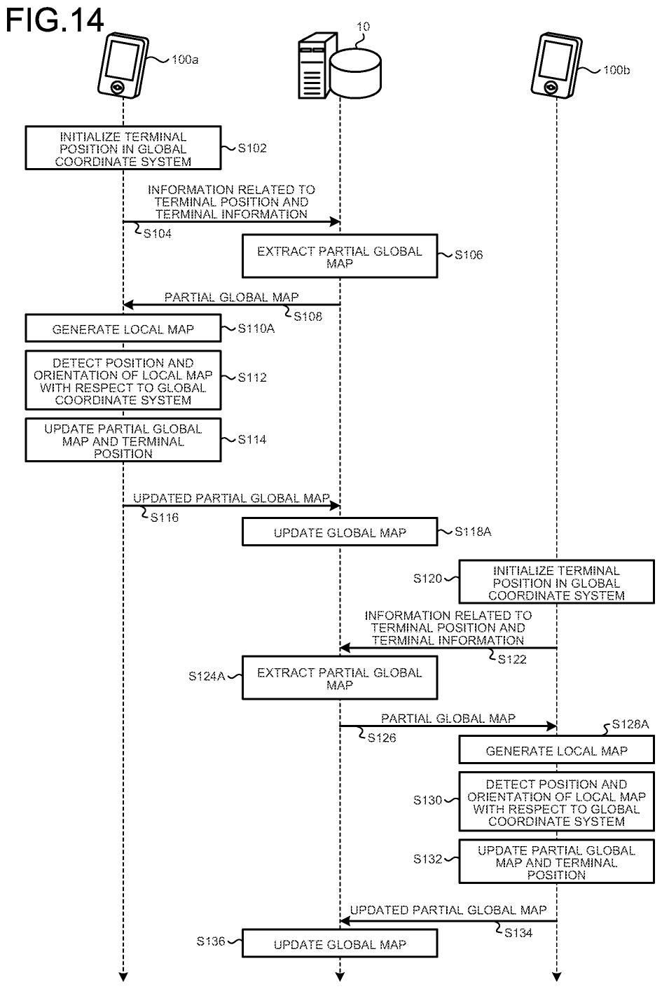

Processing to update a global map between a plurality of terminals extracting different feature values will be described by using FIG. 14. FIG. 14 is a sequence diagram illustrating an example of a flow of processing to update a global map between a plurality of terminals.

In FIG. 14, description will be given assuming that the terminal device 100a is a terminal device that utilizes a BRIEF feature value and the terminal device 100b is a terminal device that utilizes an ORB feature value.

Compared with the processing in FIG. 11, the processing in FIG. 14 is different in the processing in Step S110A, Step S118A, Step S124A, and Step S128A, and other processing is the same. Therefore, in the processing in FIG. 14, description of the same processing as the processing in FIG. 11 will be omitted. Furthermore, regarding the processing in Step S110A, Step S118A, Step S124A, and Step S128A, description of the processing similar to the processing in Step S110, Step S118, Step S124, and Step S128 will be omitted.

After the processing in Step S108, the local map generation unit 140 of the terminal device 100a extracts the BRIEF feature value from the input image and generates a local map representing a position of a body around (Step S110A).

After the processing in Step S116, the update unit 50 of the map management server 10 updates the global map stored in the global map storage unit 30 by using the position data of the body included in the updated partial global map. Furthermore, the update unit 50 extracts the ORB feature value from a taken image. Furthermore, the partial global map of the ORB feature value is updated on the basis of the partial global map of the updated BRIEF feature value. Then, on the basis of the partial global map of the updated ORB feature value, the global map of the ORB feature value stored in the global map storage unit 30 is updated (Step S118A).

After the processing in Step S122, the partial global map extraction unit 40 of the map management server 10 extracts the partial global map of the ORB feature value from the global map storage unit 30 (Step S124A). Here, the partial global map of the ORB feature value updated by the update unit 50 in Step S118 is extracted.

After the processing in Step S126, the local map generation unit 140 of the terminal device 100b generates a local map of the ORB feature value (Step S128A).

[First Modification]

Although cases where terminal information is different between terminal devices and where feature values extracted from an image is different between terminal devices have been described in the above, the present disclosure is not limited to this. In the present disclosure, a type of camera mounted on a terminal may be different. For example, the imaging unit 110 of the terminal device 100a may include only a visible light sensor, and the imaging unit 110 of the terminal device 100b may include a visible light sensor and a Time of Flight (ToF) sensor.

FIG. 15 illustrates an example of image data captured by the terminal device 100a. As illustrated in FIG. 15, the terminal device 100a generates visible light image data C1a by the visible light sensor of the imaging unit 110.

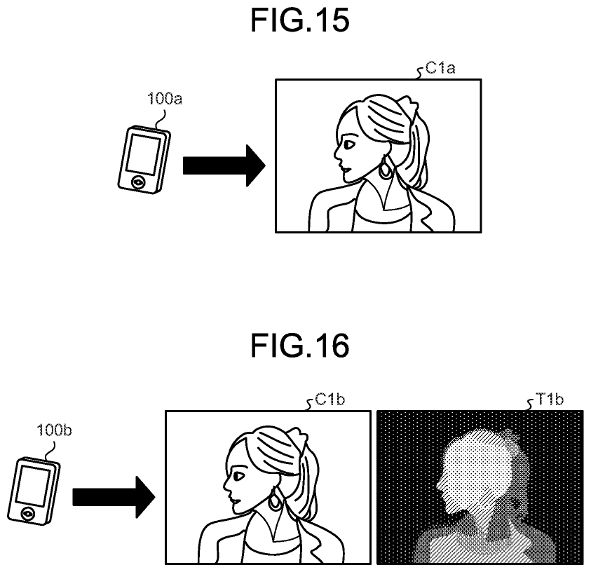

FIG. 16 illustrates an example of image data captured by the terminal device 100b. As illustrated in FIG. 16, the terminal device 100b generates visible light image data C1b by the visible light sensor of the imaging unit 110. Furthermore, the terminal device 100b generates ToF image data T1b that corresponds to visible light image data C1b by a ToF sensor of the imaging unit 110.

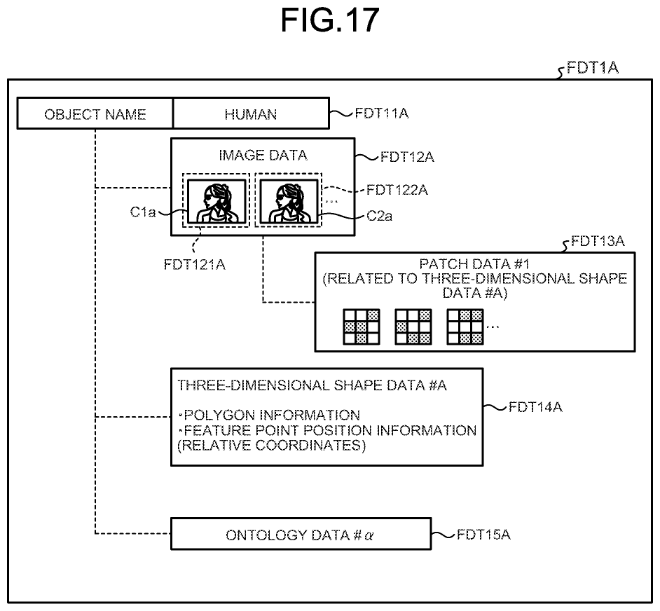

FIG. 17 is an explanatory diagram for describing an example of a configuration of feature data stored in the terminal device 100a. FIG. 17 illustrates feature data FDT1A stored in the terminal device 100a. The feature data FDT1A includes an object name FDT11A, image data FDT12A, patch data FDT13A, three-dimensional shape data FDT14A, and ontology data FDT15A.

As illustrated in the image data FDT12A, the terminal device 100a stores, for example, first image data FDT121A and second image data FDT122A. The first image data FDT121A includes the visible light image data C1a. The second image data FDT122A includes visible light image data C2a. That is, the terminal device 100a stores only visible light image data.

Because the object name FDT11A, patch data FDT13A, three-dimensional shape data FDT14A, and ontology data FDT15A are similar to the object name FDT11, patch data FDT13, three-dimensional shape data FDT14, and ontology data FDT15 illustrated in FIG. 8 respectively, the description thereof will be omitted.

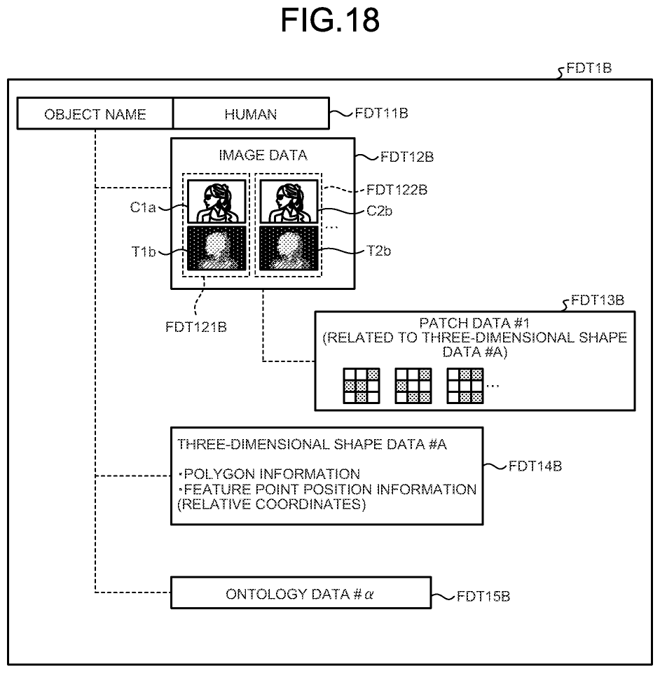

FIG. 18 is an explanatory diagram for describing an example of a configuration of feature data stored in the terminal device 100b. FIG. 18 illustrates feature data FDT1B stored in the terminal device 100b. The feature data FDT1B includes an object name FDT11B, image data FDT12B, patch data FDT13B, three-dimensional shape data FDT14B, and ontology data FDT15B.

As illustrated in the image data FDT12B, the terminal device 100b stores, for example, first image data FDT121B and second image data 122B. The image data FDT121B includes visible light image data C1b and ToF image data T1b. The image data FDT122B includes visible light image data C2b and ToF image data T2b. That is, the terminal device 100b stores visible light image data and ToF image data.

Because the object name FDT11B, patch data FDT13B, three-dimensional shape data FDT14B, and ontology data FDT15B are similar to the object name FDT11, patch data FDT13, three-dimensional shape data FDT14, and ontology data FDT15 illustrate in FIG. 8 respectively, the description thereof will be omitted.

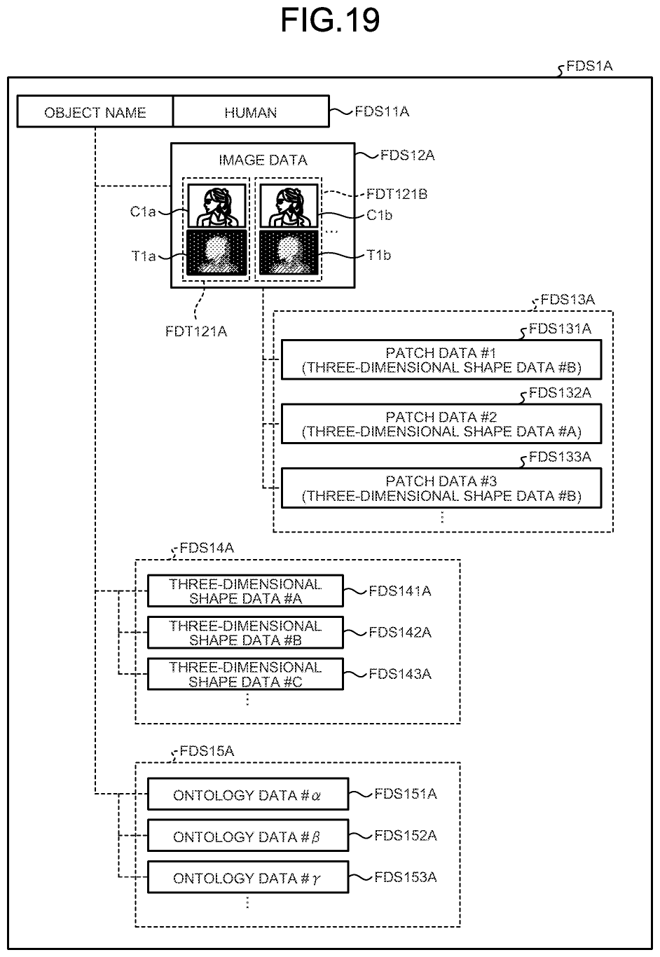

FIG. 19 illustrates an explanatory diagram for describing an example of a configuration of feature data stored in the map management server 10 in a case where the imaging unit 110 of the terminal device 100a includes only a visible light sensor, and the imaging unit 110 of the terminal device 100b includes a visible light sensor and a ToF sensor. As illustrated in FIG. 19, feature data FDS1A includes an object name FDS11A, image data FDS12A, patch data FDS13A, three-dimensional shape data FDS14A, and ontology data FDS15A.

The image data FDS12A includes first image data FDT121A and second image data FDT121B. As illustrated in FIG. 17, the first image data FDT121A is image data captured by the terminal device 100a. As illustrated in FIG. 18, the second image data FDT121B is image data captured by the terminal device 100b. Here, the image data FDT121A is associated with terminal information of the terminal device 100a. The image data FDT121B is associated with terminal information of the terminal device 100b. With this arrangement, in the map management server 10, whether or not a ToF sensor is mounted on each terminal device can be recognized.

Here, as illustrated in FIG. 19, the first image data FDT121A includes visible light image data C1a and ToF image data T1a. That is, the map management server 10 generates ToF image data T1a on the basis of the visible light image data C1a. Specifically, the update unit 50 of the map management server 10 generates ToF image data T1a on the basis of the visible light image data C1a. In this case, the global map storage unit 30 is only required to store a program for generating a ToF image from the visible light image.

Because the object name FDS11A, patch data FDS13A, three-dimensional shape data FDS14A, and ontology data FDS15A are similar to the object name FDS11, patch data FDS13, three-dimensional shape data FDS14, and ontology data FDS15 illustrated in FIG. 9 respectively, the description thereof will be omitted.

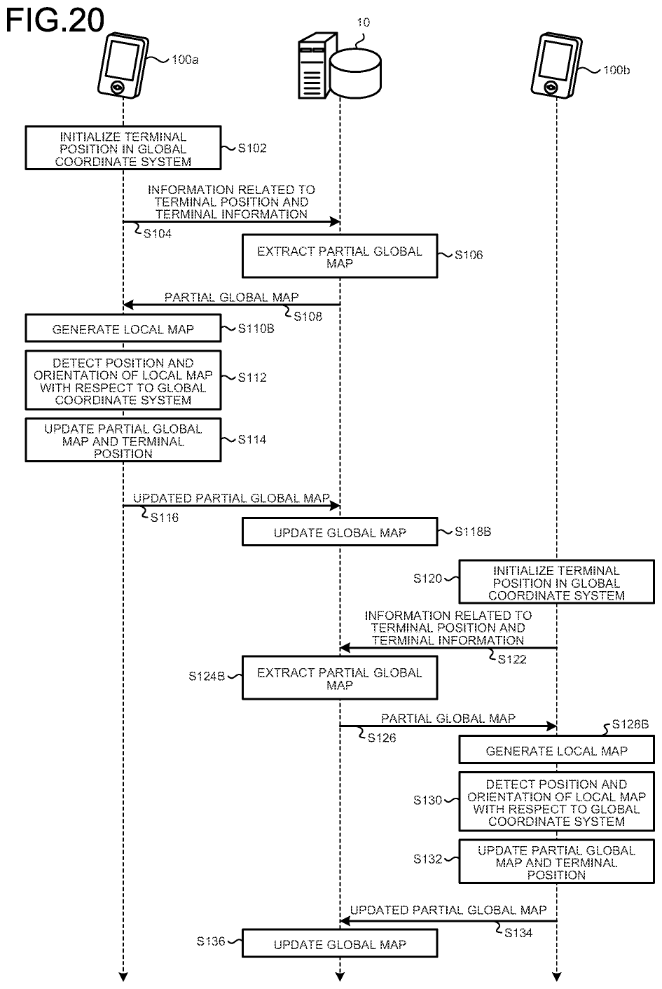

By using FIG. 20, processing to update a global map between a terminal device on which a ToF sensor is not mounted and a terminal device on which a ToF sensor is mounted will be described. FIG. 14 is a sequence diagram illustrating an example of a flow of processing to update a global map between a terminal device on which a ToF sensor is not mounted and a terminal device on which a ToF sensor is mounted.

In FIG. 14, description will be given assuming that the terminal device 100a is the terminal device on which a ToF sensor is not mounted and the terminal device 100b is the terminal device on which a ToF sensor is mounted.

Compared with the processing in FIG. 11, the processing in FIG. 20 is different in the processing in Step S110B, Step S118B, Step S124B, and Step S128B, and other processing is the same. Therefore, in the processing in FIG. 20, description of the same processing as the processing in FIG. 11 will be omitted. Furthermore, regarding the processing in Step S110B, Step S118B, Step S124B, and Step S128B, description of the processing similar to the processing in Step S110, Step S118, Step S124, and Step S128 will be omitted.

After the processing in Step S108, the local map generation unit 140 of the terminal device 100a generates a local map including visible light image data (Step S110B).

After the processing in Step S116, the update unit 50 of the map management server 10 updates the global map stored in the global map storage unit 30 by using the position data of the body included in the updated partial global map. Furthermore, the update unit 50 extracts the ToF image data from a taken image. Furthermore, the partial global map of the ToF image data is updated on the basis of the updated partial global map of the visible light image data. Then, on the basis of the updated partial global map including the ToF image data, the global map including the ToF image data, which is stored in the global map storage unit 30, is updated (Step S118B). In other words, in Step S118B, ToF image data is generated from the visible light image data.

After the processing in Step S122, the partial global map extraction unit 40 of the map management server 10 extracts the partial global map including the visible light image data and the ToF image data from the global map storage unit 30 (Step S124B). Here, the visible light image data and the ToF image data extracted in Step S124B are the visible light image data and the ToF image data updated by the update unit 50 in Step S118.

After the processing in Step S126, the local map generation unit 140 of the terminal device 100b generates a local map including visible light image data and the ToF image data (Step S128B).

[Second Modification]

In the first modification, processing to update a global map in the map management server 10 between terminals having different types of imaging units has been described. However, in the present embodiment, a global map in the map management server 10 can be updated even between terminals having different image resolution of the imaging units.

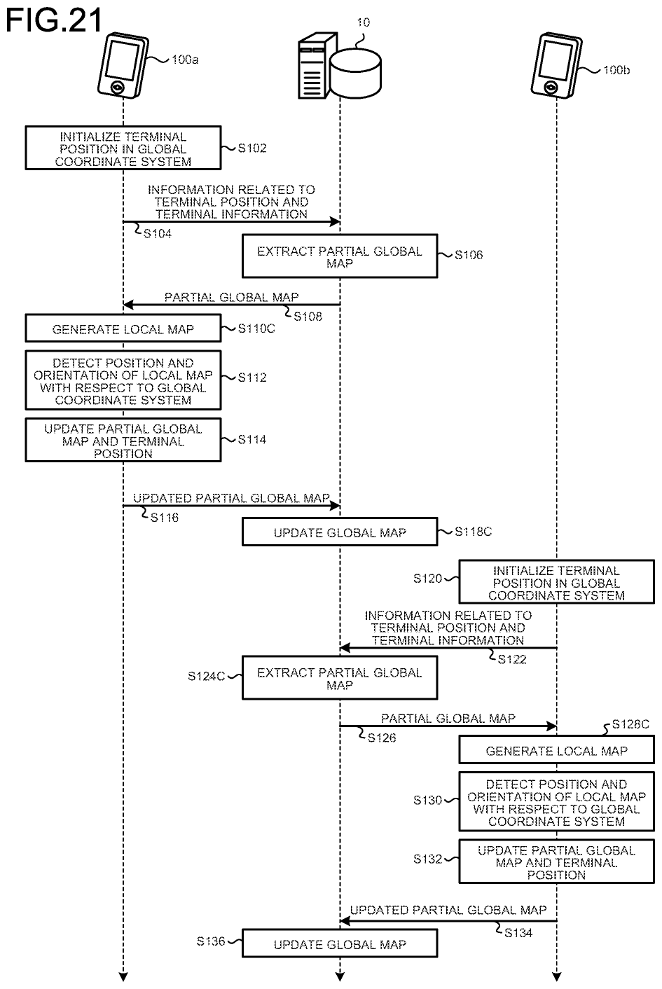

Processing to update a global map between a plurality of terminals having different image resolutions will be described by using FIG. 21. FIG. 21 is a sequence diagram illustrating an example of a flow of processing to update a global map between a plurality of terminals.

In FIG. 21, description will be given assuming that image resolution of the terminal device 100a is 1280×960 and image resolution of the terminal device 100b is 640×480.

Compared with the processing in FIG. 11, the processing in FIG. 21 is different in the processing in Step S110C, Step S118C, Step S124C, and Step S128C, and other processing is the same. Therefore, in the processing in FIG. 21, description of the same processing as the processing in FIG. 11 will be omitted. Furthermore, regarding the processing in Step S110C, Step S118C, Step S124C, and Step S128C, description of the processing similar to the processing in Step S110, Step S118, Step S124, and Step S128 will be omitted.

After the processing in Step S108, the local map generation unit 140 of the terminal device 100a extracts a feature point from the input image at resolution of 1280×960. With this arrangement, a local map is generated (Step S110C).

After the processing in Step S116, the update unit 50 of the map management server 10 updates the global map stored in the global map storage unit 30. Furthermore, the update unit 50 reduces the image data having image resolution of 1280×960 and generates an image having image resolution of 640×480. Then, the update unit 50 extracts the feature point of the image having image resolution of 640×480. With this arrangement, a partial global map of an image having image resolution of 640×480 is updated. Then, on the basis of the partial global map of the image having updated image resolution of 640×480, a global map of the image having image resolution of 640×480 stored in the global map storage unit 30 is updated (Step S118C). In order to execute processing in Step S118, for example, the global map storage unit 30 is only required to store a program that generates image data having different image resolutions from the image data.

After the processing in Step S122, the partial global map extraction unit 40 of the map management server 10 extracts the partial global map of the image having image resolution of 640×480 from the global map storage unit 30 (Step S124C). Here, the partial global map of the image having image resolution of 640×480 updated by the update unit 50 in Step S118 is extracted.

After the processing in Step S126, the local map generation unit 140 of the terminal device 100b extracts a feature point of the image having image resolution of 640×480. With this arrangement, a local map is generated (Step S128C).

Note that, image resolutions of two terminal devices have been described as different in a second modification, which is exemplification and does not limit the present invention. For example, angles of view, lens distortion, or sensor sensitivity of the two terminal devices may be different.

[Third Modification]

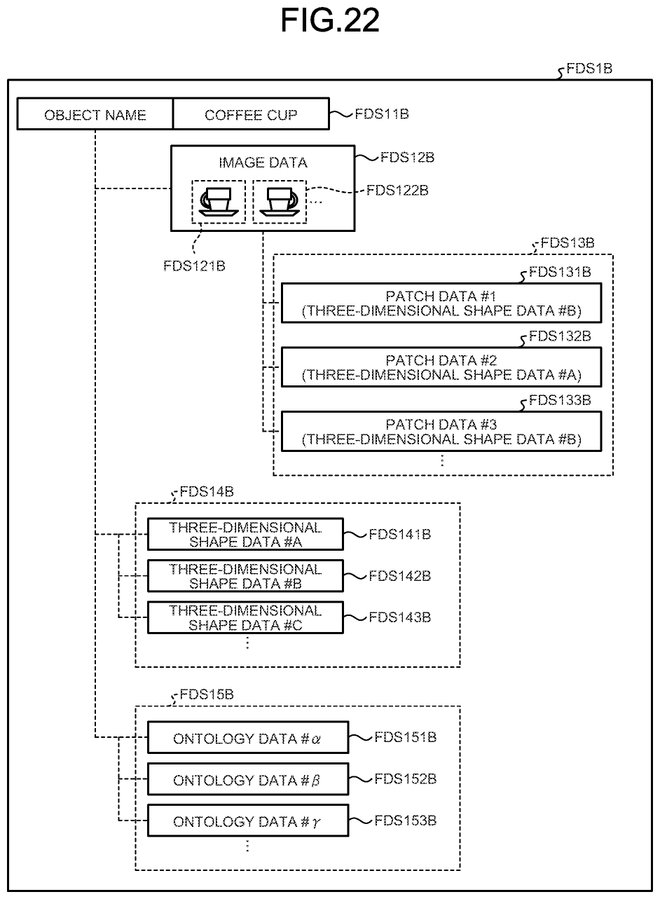

A method for reducing data capacity of the map management server 10 will be described by using FIG. 22. FIG. 22 is an explanatory diagram for describing an example of a configuration of feature data stored in the map management server 10. As illustrated in FIG. 22, feature data FDS1B includes an object name FDS11B, image data FDS12B, patch data FDS13B, three-dimensional shape data FDS14B, and ontology data FDS15B.

The image data FDS12B includes first image data FDS121B and second image data FDS122B. The first image data FDS121B is, for example, image data captured by the terminal device 100a. The second image data FDS122B is, for example, image data captured by the terminal device 100b.

Here, if the second image data FDS122B can be created, for example, by reducing the first image data FDS121B, the map management server 10 does not have to store the second image data FDS122B. In this case, the map management server 10 is only required to generate the second image data FDS122B on the basis of the first image data FDS121B. With this arrangement, the map management server 10 is not required to store the second image data FDS122B, and therefore, data capacity can be reduced.

Note that the second image data FDS122B has been described as being able to be generated by reducing the first image data FDS121B, which is exemplification and does not limit the present invention. By converting brightness of the first image data FDS121B or executing geometric transformation such as affine transformation on the first image data FDS121B, the second image data FDS122B is not required to be stored, even in a case where the second image data FDS122B can be generated.

### 6. Hardware Configuration

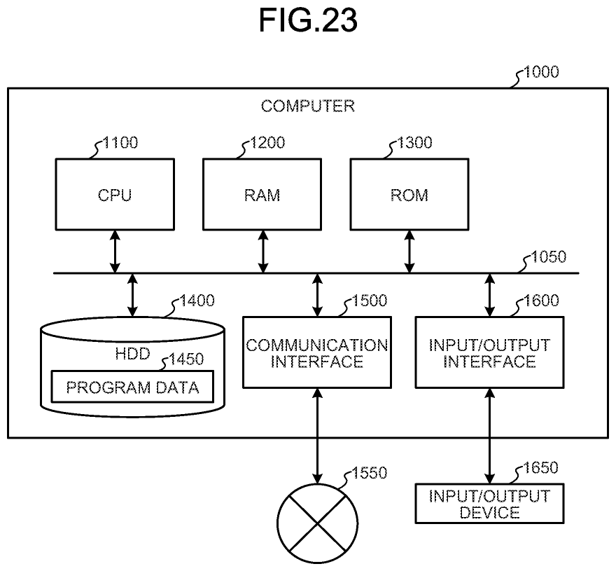

The map management server 10 and the terminal device 100 according to each of the above-described embodiments are implemented by, for example, a computer 1000 having a configuration as illustrated in FIG. 23. FIG. 23 is a hardware configuration diagram illustrating an example of the computer 1000 that implements a function of the map management server 10 and terminal device 100. The computer 1000 has a CPU 1100, RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 expands a program stored in the ROM 1300 or the HDD 1400 to the RAM 1200 and executes processing corresponding to various programs.

The ROM 1300 stores a boot program such as a basic input output system (BIOS) executed by the CPU 1100 when the computer 1000 starts up, a program dependent on the hardware of the computer 1000, or the like.

The HDD 1400 is a computer-readable recording medium that non-temporarily records a program executed by the CPU 1100 and data used by the program, or the like. Specifically, the HDD 1400 is a recording medium that records a program according to the present disclosure, which is an example of program data 1450.

The communication interface 1500 is an interface for the computer 1000 to connect to an external network 1550 (for example, the Internet). For example, via the communication interface 1500, the CPU 1100 receives data from another apparatus or transmits data generated by the CPU 1100 to another apparatus.

The input/output interface 1600 is an interface for connecting an input/output device 1650 and the computer 1000. For example, the CPU 1100 receives data from an input device such as a keyboard or a mouse via the input/output interface 1600. Furthermore, the CPU 1100 transmits data to an output device such as a display, a speaker, or a printer via the input/output interface 1600. Furthermore, the input/output interface 1600 may function as a media interface that reads a program, or the like, recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the map management server 10 and the terminal device 100 according to a first embodiment, the CPU 1100 of the computer 1000 implements a function of each unit by executing a program loaded on the RAM 1200. Furthermore, a program according to the present disclosure is stored in the HDD 1400. Note that, although the CPU 1100 reads the program data 1450 from the HDD 1400 and executes the program data 1450, the CPU 1100 may, as another example, acquire these programs from another device via the external network 1550.

Note that the effects described in the present specification are only examples, and the effects of the present technology are not limited to these effects. Additional effects may also be obtained.

Note that the present technology can have the following configurations.

(1)

An information processing device comprising:

an acquisition unit that acquires, from a first terminal device, first image data and first terminal information associated with the first terminal device; and

a generation unit that generates, on the basis of the first image data, second image data corresponding to second terminal information that is different from the first terminal information.

(2)

The information processing device according to (1),

wherein the acquisition unit acquires position information related to a position of the first terminal device.

(3)

The information processing device according to (2), the information processing device further comprising

an extraction unit that extracts, on the basis of the first terminal information and the position information, first partial image data corresponding to the position information associated with the first terminal information from first whole image data associated with the first terminal information.

(4)

The information processing device according to (3),

wherein the first image data is image data in which the first partial image data is updated by the first terminal device, and the generation unit updates the first whole image data on the basis of the first image data.

(5)

The information processing device according to (3) or (4),

wherein the extraction unit extracts second partial image data associated with the second terminal information from second whole image data associated with the second terminal information on the basis of the position information, and

the generation unit generates the second image data from the second partial image data on the basis of the first image data.

(6)

The information processing device according to (5),

wherein the generation unit updates the second whole image data on the basis of the second image data.

(7)

The information processing device according to (5) or (6),

wherein the generation unit integrates a body registered more than once in the first whole image data and the second whole image data.

(8)

The information processing device according to any one of (5) to (7),

wherein the first whole image data and the second whole image data are a global map, and the first partial image data and the second partial image data are a partial global map.

(9)

A terminal device comprising:

a terminal information transmission unit that transmits first terminal information; and

an acquisition unit that transmits current position information to an information processing device and acquires, from the information processing device, first image data corresponding to the first terminal information and the position information, the first image data being generated on the basis of second terminal information that is different from the first terminal information.

(10)

The terminal device according to (9), the terminal device further comprising

an update unit that updates the first image data by associating the first image data with the first terminal information.

(11)

The terminal device according to (10), the terminal device further comprising a storage unit that holds at least patch image data, three-dimensional shape data, and ontology data,

wherein the update unit updates at least one of the patch image data, the three-dimensional shape data, and the ontology data by associating the data with the first image data.

(12)

An information processing system comprising:

an information processing device; and

a terminal device,

wherein the information processing device includes

an acquisition unit that acquires, from the terminal device, first image data and first terminal information associated with the terminal device, and

a generation unit that generates, on the basis of the first image data, second image data corresponding to second terminal information that is different from the first terminal information, and

the terminal device includes

a terminal information transmission unit that transmits first terminal information, and

an acquisition unit that transmits current position information to an information processing device and acquires, from the information processing device, first image data corresponding to the first terminal information and the position information, the first image data being generated on the basis of second terminal information that is different from the first terminal information.

(13)

An information processing method comprising:

acquiring, from a first terminal device, first image data and first terminal information associated with the first terminal device; and

generating, on the basis of the first image data, second image data corresponding to second terminal information that is different from the first terminal information.

(14)

An information processing method comprising:

transmitting first terminal information and position information to an information processing device; and

receiving, from the information processing device, first image data corresponding to the first terminal information and the position information, the first image data being generated on the basis of second terminal information that is different from the first terminal information.

(15)

A program for causing a computer included in an information processing device to function as:

an acquisition unit that acquires, from a first terminal device, first image data and first terminal information associated with the first terminal device; and

a generation unit that generates, on the basis of the first image data, second image data corresponding to second terminal information that is different from the first terminal information.

(16)

A program for causing a computer included in an information processing device to function as:

a transmission unit that transmits first terminal information and position information to an information processing device; and

a reception unit that receives, from the information processing device, first image data corresponding to the first terminal information and the position information, the first image data being generated on the basis of second terminal information that is different from the first terminal information.

### REFERENCE SIGNS LIST

10 Map management server
20 Communication interface
30 Global map storage unit
40 Partial global map extraction unit
50 Update unit
60 Global map distribution unit
100, 100a, 100b Terminal device
102 Communication interface
110 Imaging unit
120 Initialization unit
130 Global map acquisition unit
132 Storage unit
140 Local map generation unit
160 Calculation unit
170 Conversion unit
180 Update unit
190 Terminal information transmission unit
200 Display control unit

1. An information processing device comprising:
an acquisition unit that acquires, from a first terminal device, first image data and first terminal information associated with the first terminal device; and
a generation unit that generates, on the basis of the first image data, second image data corresponding to second terminal information that is different from the first terminal information.

2. The information processing device according to claim 1,
wherein the acquisition unit acquires position information related to a position of the first terminal device.

3. The information processing device according to claim 2, the information processing device further comprising
an extraction unit that extracts, on the basis of the first terminal information and the position information, first partial image data corresponding to the position information associated with the first terminal information from first whole image data associated with the first terminal information.

4. The information processing device according to claim 3,
wherein the first image data is image data in which the first partial image data is updated by the first terminal device, and the generation unit updates the first whole image data on the basis of the first image data.

5. The information processing device according to claim 4,
wherein the extraction unit extracts second partial image data associated with the second terminal information from second whole image data associated with the second terminal information on the basis of the position information, and
the generation unit generates the second image data from the second partial image data on the basis of the first image data.

6. The information processing device according to claim 5,
wherein the generation unit updates the second whole image data on the basis of the second image data.

7. The information processing device according to claim 5,
wherein the generation unit integrates a body registered more than once in the first whole image data and the second whole image data.

8. The information processing device according to claim 5,
wherein the first whole image data and the second whole image data are a global map, and the first partial image data and the second partial image data are a partial global map.

9. A terminal device comprising:
a terminal information transmission unit that transmits first terminal information; and
an acquisition unit that transmits current position information to an information processing device and acquires, from the information processing device, first image data corresponding to the first terminal information and the position information, the first image data being generated on the basis of second terminal information that is different from the first terminal information.

10. The terminal device according to claim 9, the terminal device further comprising
an update unit that updates the first image data by associating the first image data with the first terminal information.

11. The terminal device according to claim 10, the terminal device further comprising
a storage unit that holds at least patch image data, three-dimensional shape data, and ontology data,
wherein the update unit updates at least one of the patch image data, the three-dimensional shape data, and the ontology data by associating the data with the first image data.

12. An information processing system comprising:
an information processing device; and
a terminal device,
wherein the information processing device includes
an acquisition unit that acquires, from the terminal device, first image data and first terminal information associated with the terminal device, and
a generation unit that generates, on the basis of the first image data, second image data corresponding to second terminal information that is different from the first terminal information, and
the terminal device includes
a terminal information transmission unit that transmits first terminal information, and
an acquisition unit that transmits current position information to an information processing device and acquires, from the information processing device, first image data corresponding to the first terminal information and the position information, the first image data being generated on the basis of second terminal information that is different from the first terminal information.

13. An information processing method comprising:
acquiring, from a first terminal device, first image data and first terminal information associated with the first terminal device; and
generating, on the basis of the first image data, second image data corresponding to second terminal information that is different from the first terminal information.

14. An information processing method comprising:
transmitting first terminal information and position information to an information processing device; and
receiving, from the information processing device, first image data corresponding to the first terminal information and the position information, the first image data being generated on the basis of second terminal information that is different from the first terminal information.

15. A program for causing a computer included in an information processing device to function as:
an acquisition unit that acquires, from a first terminal device, first image data and first terminal information associated with the first terminal device; and
a generation unit that generates, on the basis of the first image data, second image data corresponding to second terminal information that is different from the first terminal information.

16. A program for causing a computer included in an information processing device to function as:
a transmission unit that transmits first terminal information and position information to an information processing device; and
a reception unit that receives, from the information processing device, first image data corresponding to the first terminal information and the position information, the first image data being generated on the basis of second terminal information that is different from the first terminal information.
